(19) United States
(12) Patent Application Publication
(10) Pub. No.: US 2019/0005424 A1
(43) Pub. Date: Jan. 3, 2019

(54) SYSTEMS AND METHODS FOR PROVIDING ACTIONABLE DATA INSIGHTS

(71) Applicant: Facebook, Inc., Menlo Park, CA (US)

(72) Inventors: Vincent Gonguet, Menlo Park, CA (US); Cinna Julie Wu, Milpitas, CA (US); India Swearingen, Oakland, CA (US); Austin Chang, San Francisco, CA (US); Heather Monley, Santa Clara, CA (US); James Donovan, San Francisco, CA (US); Shuchen Zheng, San Jose, CA (US)

(21) Appl. No.: 15/639,329

(22) Filed: Jun. 30, 2017

(51) Int. Cl. G06Q 10/06; G06Q 50/00

(52) U.S. Cl. CPC G06Q 10/0637; G06Q 30/0201; G06Q 50/01

(57) ABSTRACT

Systems, methods, and non-transitory computer-readable media can be configured to perform determining a request to create a highlight story that addresses one or more goals of an organization, wherein the highlight story is created based at least in part on one or more specified parameters. The highlight story can be generated based at least in part on the one or more parameters and from data describing customers of the organization. The highlight story can be published in a newsfeed associated with the organization, the newsfeed being accessible through a social networking system.

### FIELD OF THE INVENTION

The present technology relates to the field of data analytics. More particularly, the present technology relates to techniques for providing actionable data insights.

### BACKGROUND

Today, people often utilize computing devices (or systems) for a wide variety of purposes. Users can use their computing devices to, for example, interact with one another, access content, share content, and create content. In some cases, content items can include postings from members of a social network. The postings may include text and media content items, such as images, videos, and audio. The postings may be published to the social network for consumption by others.

### SUMMARY

Various embodiments of the present disclosure can include systems, methods, and non-transitory computer readable media configured to determine a request to create a highlight story that addresses one or more goals of an organization, wherein the highlight story is created based at least in part on one or more specified parameters; generate the highlight story based at least in part on the one or more parameters and from data describing customers of the organization; and cause the highlight story to be published in a newsfeed associated with the organization, the newsfeed being accessible through a social networking system.

In an embodiment, the one or more parameters include one or more of a specified geographic region, a market segment, or a product type.

In an embodiment, the highlight story is associated with at least one query for generating a visualization based at least in part on the one or more specified parameters, wherein the visualization is accessible upon selection of the highlight story.

In an embodiment, the visualization includes at least an interactive map corresponding to a specified geographic region, wherein the interactive map provides a visual distribution of a specified market segment within the geographic region.

In an embodiment, a goal corresponds to at least one of: a goal for increasing market share, a goal for improving customer retention, a goal for a product launch, a goal for increasing margins, a goal for optimizing media spend, a goal for optimizing a local strategy, or a goal for customer acquisition.

In an embodiment, the systems, methods, and non-transitory computer readable media are configured to perform converting the highlight story to a rule, wherein the rule is used to generate one or more highlight stories for other organizations to achieve the one or more goals.

In an embodiment, the systems, methods, and non-transitory computer readable media are configured to perform identifying at least one corresponding token for each of the one or more parameters; and replacing the one or more parameters with their corresponding tokens, wherein each token serves as a placeholder for a parameter value.

In an embodiment, the systems, methods, and non-transitory computer readable media are configured to perform determining that the highlight story has received a threshold amount of interaction by one or more users associated with the first organization.

In an embodiment, the systems, methods, and non-transitory computer readable media are configured to perform generating at least one second highlight story that provides insights for achieving the one or more goals by a second organization, wherein the second highlight story is generated based at least in part on the rule and data describing customers of the second organization.

In an embodiment, the second highlight story is generated in response to the second organization not having satisfied a given goal by some specified threshold amount.

It should be appreciated that many other features, applications, embodiments, and/or variations of the disclosed technology will be apparent from the accompanying drawings and from the following detailed description. Additional and/or alternative implementations of the structures, systems, non-transitory computer readable media, and methods described herein can be employed without departing from the principles of the disclosed technology.

### BRIEF DESCRIPTION OF THE DRAWINGS

FIG. 1 illustrates an example system including an example data insights module, according to an embodiment of the present disclosure.

FIG. 2 illustrates an example of a highlights module, according to an embodiment of the present disclosure.

FIG. 3 illustrates an example of a story management module, according to an embodiment of the present disclosure.

FIGS. 4A-4C illustrate example diagrams, according to various embodiments of the present disclosure.

FIG. 5 illustrates an example process, according to various embodiments of the present disclosure.

FIG. 6 illustrates a network diagram of an example system including an example social networking system that can be utilized in various scenarios, according to an embodiment of the present disclosure.

FIG. 7 illustrates an example of a computer system or computing device that can be utilized in various scenarios, according to an embodiment of the present disclosure.

The figures depict various embodiments of the disclosed technology for purposes of illustration only, wherein the figures use like reference numerals to identify like elements. One skilled in the art will readily recognize from the following discussion that alternative embodiments of the structures and methods illustrated in the figures can be employed without departing from the principles of the disclosed technology described herein.

### DETAILED DESCRIPTION

### Providing Actionable Data Insights

Organizations typically rely on data analytics to determine various customer and business insights. In general, conventional tools for performing such analyses are typically designed for more advanced users. Since not all organizations have access to such advanced users, users with less experience often have difficulty using such conventional tools and, therefore, may not be able to obtain the insights needed to achieve various organizational goals. Accordingly, such conventional approaches may not be effective in addressing these and other problems arising in computer technology.

An improved approach rooted in computer technology overcomes the foregoing and other disadvantages associated with conventional approaches specifically arising in the realm of computer technology. For example, a request to create a highlight story that addresses one or more goals of an organization can be determined. The highlight story can be created based at least in part on one or more specified parameters. The highlight story can be generated based at least in part on the one or more parameters and from data describing customers of the organization. The highlight story can be published in a newsfeed associated with the organization, the newsfeed being accessible through a social networking system. More details relating to the disclosed technology are provided below.

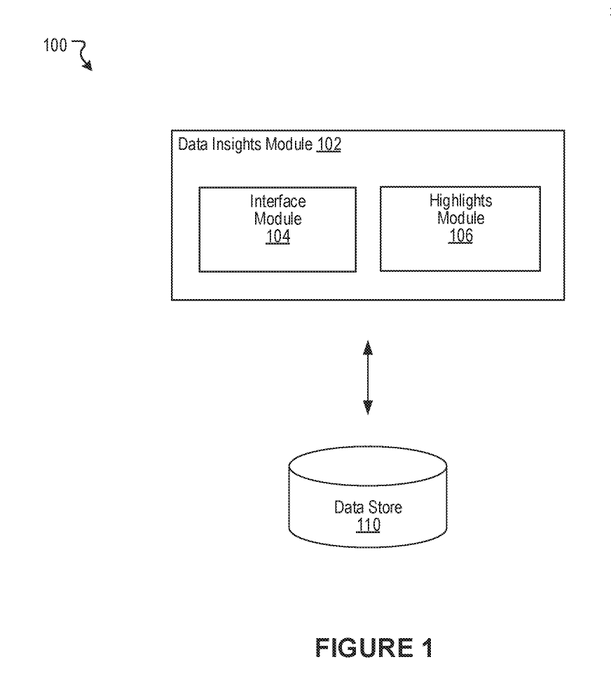

FIG. 1 illustrates an example system 100 including an example data insights module 102, according to an embodiment of the present disclosure. As shown in the example of FIG. 1, the data insights module 102 can include an interface module 104 and a highlights module 106. In some instances, the example system 100 can include at least one data store 110. The components (e.g., modules, elements, etc.) shown in this figure and all figures herein are exemplary only, and other implementations may include additional, fewer, integrated, or different components. Some components may not be shown so as not to obscure relevant details.

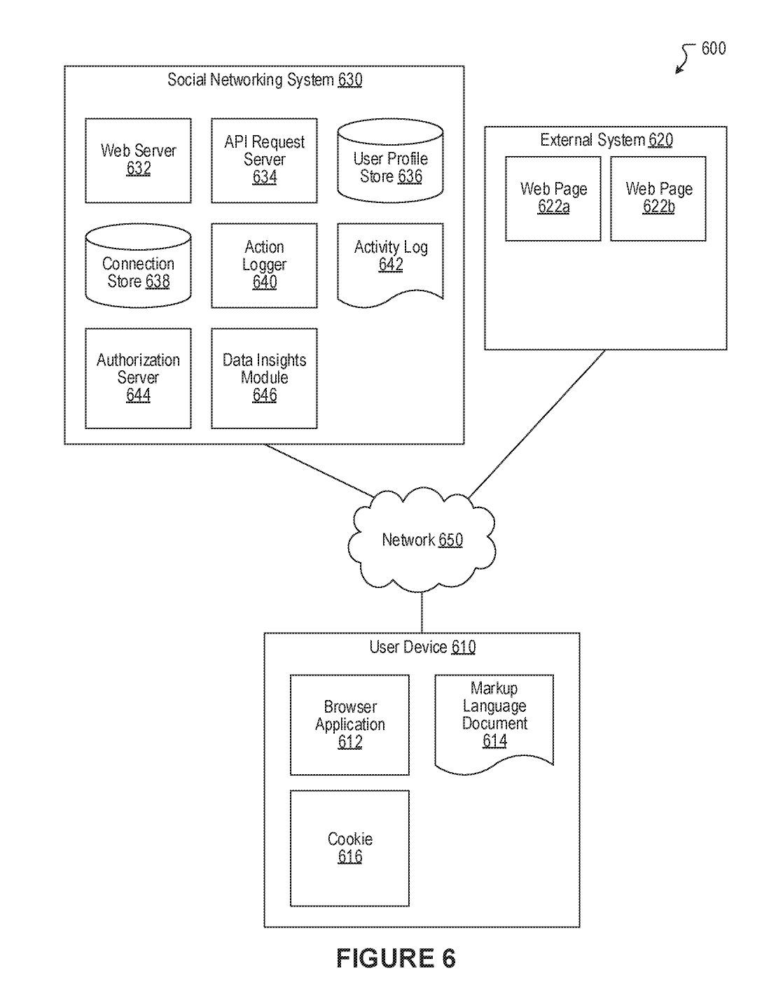

In some embodiments, the data insights module 102 can be implemented, in part or in whole, as software, hardware, or any combination thereof. In general, a module as discussed herein can be associated with software, hardware, or any combination thereof. In some implementations, one or more functions, tasks, and/or operations of modules can be carried out or performed by software routines, software processes, hardware, and/or any combination thereof. In some cases, the data insights module 102 can be implemented, in part or in whole, as software running on one or more computing devices or systems, such as on a user or client computing device. In one example, the data insights module 102 or at least a portion thereof can be implemented as or within an application (e.g., app), a program, or an applet, etc., running on a user computing device or a client computing system, such as the user device 610 of FIG. 6. In another example, the data insights module 102 or at least a portion thereof can be implemented using one or more computing devices or systems that include one or more servers, such as network servers or cloud servers. In some instances, the data insights module 102 can, in part or in whole, be implemented within or configured to operate in conjunction with a social networking system (or service), such as the social networking system 630 of FIG. 6. It should be understood that there can be many variations or other possibilities.

In some embodiments, the data insights module 102 can be configured to communicate and/or operate with the at least one data store 110 in the example system 100. In various embodiments, the at least one data store 110 can store data relevant to the function and operation of the data insights module 102 (e.g., highlights, rules, organization data, customer data, etc.). In some implementations, the at least one data store 110 can store information associated with the social networking system (e.g., the social networking system 630 of FIG. 6). The information associated with the social networking system can include data about users, social connections, social interactions, locations, geo-fenced areas, maps, places, events, pages, groups, posts, communications, content, feeds, account settings, privacy settings, a social graph, and various other types of data. In some implementations, the at least one data store 110 can store information associated with users, such as user identifiers, user information, profile information, user specified settings, content produced or posted by users, and various other types of user data. It should be appreciated that there can be many variations or other possibilities.

The interface module 104 can be configured to provide an interface (e.g., graphical user interface) through which users can access various information. For example, in some embodiments, the interface module 104 can provide users with access to various content feeds (or news feeds) through which data insights are surfaced. In some embodiments, data insights can be surfaced as highlights (or stories) that are presented in content feeds. In some embodiments, content feeds can be associated with respective entities (e.g., organizations). In such embodiments, access to an entity's content feed can be restricted to users that are affiliated, or otherwise associated, with the entity.

In various embodiments, a user accessing a given organization's content feed can be presented with a set of highlights that may be relevant to the organization. For example, some of these highlights may relate to various goals of the organization. These goals may include a goal for increasing the organization's market share, a goal relating to a product launch by the organization, a goal for increasing the organization's margins, a goal for optimizing the organization's media (or ad) spend, a goal for optimizing the organization's local strategy in some geographic region, or a goal for acquiring customers, to name some examples. In this example, the user can select a given highlight to access additional information that relates to some goal of the organization. In some embodiments, the user can filter highlights shown in the content feed based on a specific goal. For example, the user can specify a goal for increasing market share. In this example, the content feed can be filtered so that only highlights that relate to the goal of increasing market share are presented in the content feed.

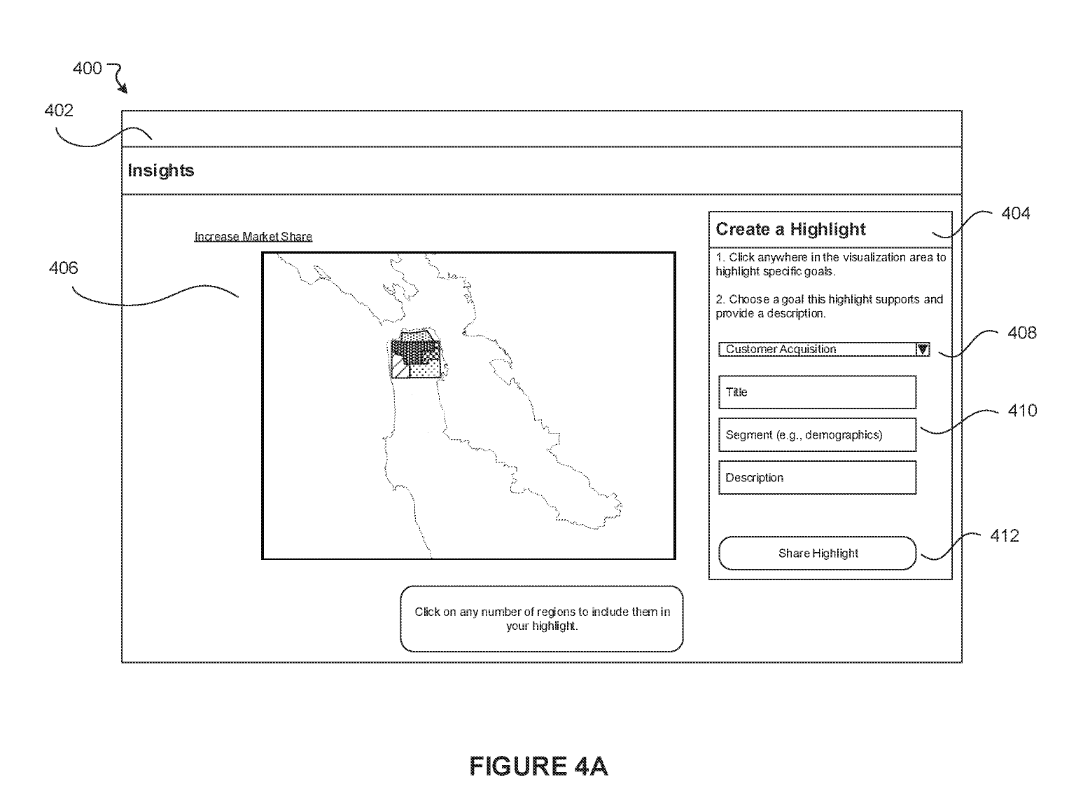

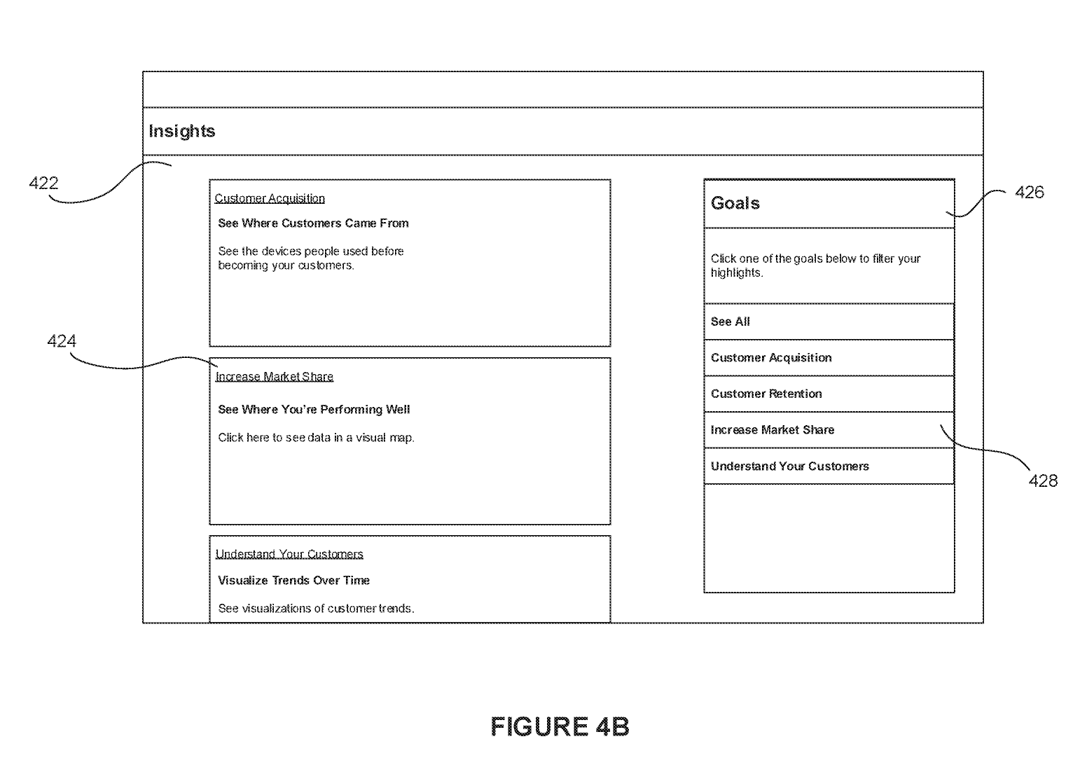

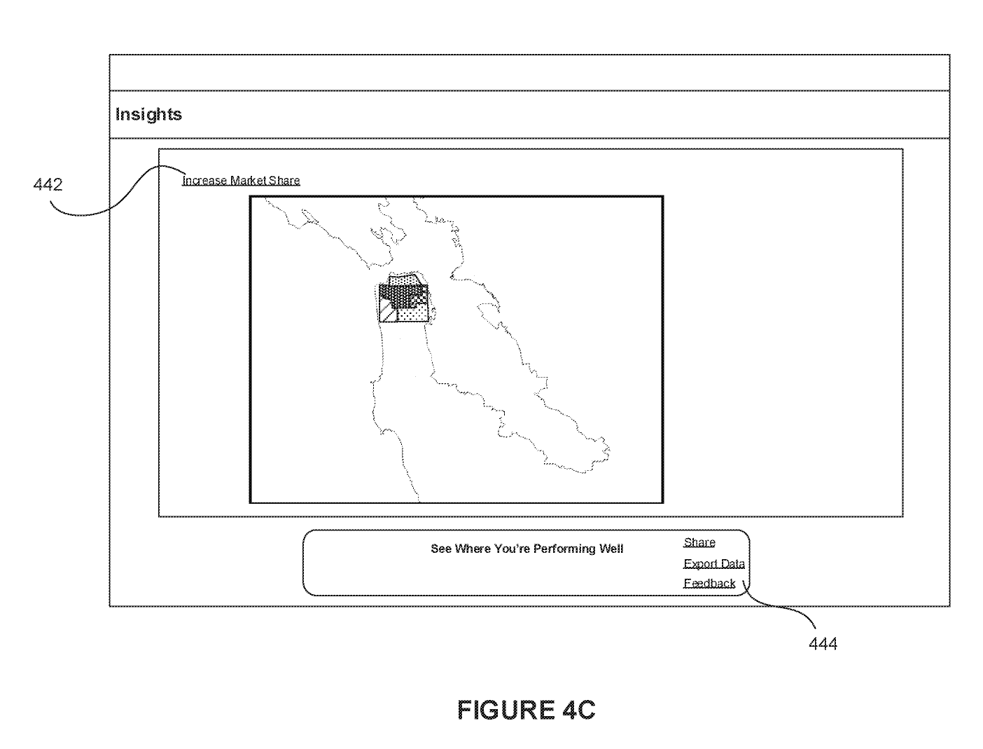

In general, a highlight can provide some view of an organization's data. For example, a highlight can provide information describing the organization's customers across various market segments (e.g., demographics, location, product type, etc.). In one example, a highlight may describe a total number of the organization's customers, a number of new customers that started using the organization's products or services over some period of time, and a number of customers that stopped using the organization's products or services over the period of time. A highlight may include additional information including, for example, a narrative that can provide advice for achieving some goal. In some embodiments, a highlight can be associated with one or more queries for generating various visualizations using an organization's data. For example, in some embodiments, a highlight can be associated with a query that is used to generate an interactive map for some geographic region based on at least some of the organization's data. In this example, the interactive map may provide a visual distribution of the organization's customers (or some specified market segment) within the geographic region. More details regarding the interface module 104 will be provided below with reference to FIGS. 4A-4C.

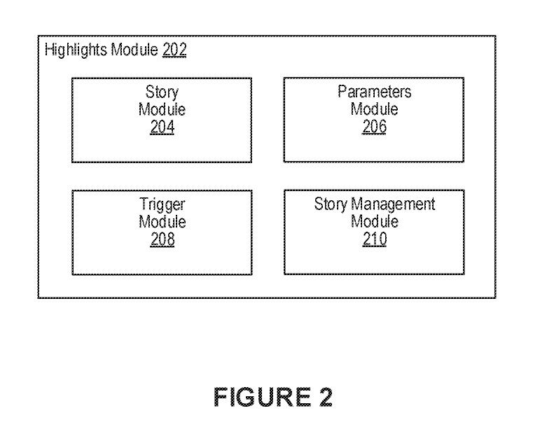

The highlights module 106 can be configured to generate highlights. In some embodiments, users affiliated with a given organization can create highlights that are customized for various goals for the organization. These customized highlights may be shared, or made accessible, to other users also affiliated with the organization. More details regarding the highlights module 106 will be provided below with reference to FIG. 2.

FIG. 2 illustrates an example of a highlights module 202, according to an embodiment of the present disclosure. In some embodiments, the highlights module 106 of FIG. 1 can be implemented as the highlights module 202. As shown in FIG. 2, the highlights module 202 can include a story module 204, a parameters module 206, a trigger module 208, and a story management module 210.

The story module 204 can be configured to create highlights (or stories) in response to user requests. In some embodiments, a user affiliated with an organization may submit a request to create a highlight that addresses some goal of the organization. In some embodiments, when creating the highlight, the user can specify a title and description for the highlight, one or more goals to be addressed by the highlight, and one or more parameters for customizing the highlight.

The parameters module 206 can provide the user with options for defining parameters to be used to generate (or customize) a highlight. In some embodiments, the parameters module 206 can provide the user with options for selecting one or more goals that are addressed by a highlight being created. As mentioned, these goals may include a goal for increasing the organization's market share, a goal relating to a product launch by the organization, a goal for increasing the organization's margins, a goal for optimizing the organization's media (or ad) spend, a goal for optimizing the organization's local strategy in some geographic region, or a goal for acquiring customers, to name some examples.

In various embodiments, the story module 204 can be configured to generate information (e.g., data analytics information, visualizations, interactive maps, etc.) to be included in a given highlight based on one or more specified goals and from data associated with an organization for which the highlight is being generated. In some embodiments, this generated information may be segmented based on various additional parameters. In such embodiments, the parameters module 206 can provide the user with options for defining segments being addressed by the highlight. For example, a user may specify one or more segments when creating a highlight. These segments may be used to customize (or restrict) information (e.g., data analytics information, visualizations, interactive maps, etc.) provided by the highlight. In some embodiments, the user can specify a segment based on one or more demographics (e.g., age group, gender, etc.). In some embodiments, the user can specify a segment based on a product (or product type) (e.g., users of some specified device or brand). In some embodiments, the user can specify one or more geographic regions being addressed by the highlight (e.g., city, county, zip code, country, continent, or any custom defined region). For example, a user may create a highlight that addresses an organization's goal directed to customer acquisition. The user may specify a geographic region (e.g., the United States) in which customer acquisition is desired. Further, the user can specify a demographic segment (e.g., age group) being targeted for customer acquisition. In this example, the story module 204 can be configured to generate information (e.g., data analytics information, visualizations, interactive maps, etc.) to be included in the highlight based on the specified goal, parameters, and from data associated with an organization for which the highlight is being generated (e.g., the organization's customer data). This information can be associated with the highlight. The highlight can then be published as a story in the organization's content feed. In general, any user that has permission to access the content feed can access the published highlight. When selected, the highlight can provide the user with the information associated with the highlight.

The trigger module 208 can be configured to automatically generate and publish highlights in content feeds. For example, in some embodiments, a user affiliated with an organization may specify one or more goal-based metric thresholds. The user may specify that highlights relating to customer acquisition should be generated and published in an organization's content feed if the organization's market share falls below some specified threshold. In some embodiments, highlights that are popular among users affiliated with some organization can automatically be customized and re-published in content feeds of other organizations. In such embodiments, such popularity may be measured based on user interactions with a given highlight including, for example, an amount of time spent by users while accessing the highlight, a number of user selections of the highlight (e.g., clicks), and/or a number of actions taken with respect to the highlight. In some embodiments, an action may correspond to exporting data from a highlight, providing feedback on the highlight, sharing the highlight, or requesting an advertisement be distributed based on parameters associated with the highlight (e.g., target an advertisement to a given demographic segment in some geographic region).

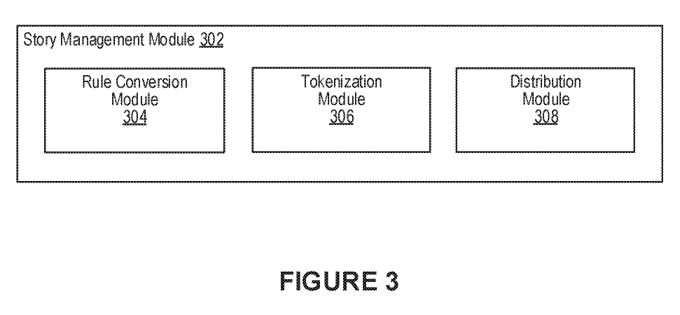

The story management module 210 can be configured to manage highlights that were created by users affiliated with various organizations. Thus, in some embodiments, the story management module 210 manages a repository of highlights that were created, either manually or automatically, to address goals of various organizations. In some embodiments, highlights created for a given organization are made available only to users that are affiliated with that organization. In some embodiments, however, a highlight that was initially created for a given organization may be converted to a rule from which similar highlights can be generated for other organizations. As a result, in some embodiments, a highlight that originally published in a content feed of one organization can be customized and re-published in a content feed of a different organization. In such embodiments, the highlight can be customized based on the different organization's data (e.g., customer data) prior to re-publication. More details regarding the story management module 210 will be provided below with reference to FIG. 3.

FIG. 3 illustrates an example of a story management module 302, according to an embodiment of the present disclosure. In some embodiments, the story management module 210 of FIG. 2 can be implemented as the story management module 302. As shown in FIG. 3, the story management module 302 can include a rule conversion module 304, a tokenization module 306, and a distribution module 308.

The rule conversion module 304 can be configured to convert highlights to rules. These rules can be used to customize and generate similar highlights for other entities (e.g., organizations). For example, a popular highlight that was initially created based on various goals of an organization can be converted to a rule. This rule can then be used to generate highlights that address those same goals for other organizations. In some embodiments, popular highlights are automatically converted into respective rules. In such embodiments, popularity may be measured based on user interactions with a given highlight including, for example, an amount of time spent by users while accessing the highlight, a number of user selections of the highlight (e.g., clicks), and/or a number of actions taken with respect to the highlight. In some embodiments, an action may correspond to exporting data from a highlight, providing feedback on the highlight, sharing the highlight, or requesting an advertisement be distributed based on parameters associated with the highlight (e.g., target advertisement to a given demographic segment in some geographic region).

In some embodiments, when converting an organization's highlight to a rule, the tokenization module 306 modifies the highlight so that information identifying the organization (or otherwise related to the organization) is replaced with corresponding tokens. This modified version of the highlight can then be stored as the rule. For example, if the highlight references the organization's name, then the organization's name can be replaced with a token that serves as a placeholder for some organization's name. Thus, for example, an organization name “Duncan Coffee” included in a highlight narrative can be replaced with a token “{Organization_Name}”. In this example, when the rule is used to generate a corresponding highlight for a different organization, any instances of the token “{Organization_Name}” can be replaced with the different organization's actual name in the highlight.

In some embodiments, when converting an organization's highlight to a rule, the tokenization module 306 also modifies the highlight so that certain parameters associated with the highlight are replaced with corresponding tokens. For example, in some embodiments, any geographic regions that were specified for a given highlight can be replaced with a corresponding token (e.g., “{Geographic_Region}”). In this example, when the rule is used to generate a corresponding highlight for a different organization, any instances of the token “{Geographic_Region}” can be replaced with any geographic regions specified by the different organization (or determined to be of interest to the different organization). In some embodiments, any demographic (or market) segments (e.g., age group, gender, etc.) that were specified for a given highlight can be replaced with a corresponding token (e.g., “{Market_Segment}”, “{Age_Group}”, “{Gender}”, etc.). In this example, when the rule is used to generate a corresponding highlight for a different organization, any instances of a given token can be replaced with segments specified by the different organization (or determined to be of interest to the different organization). For example, any instances of a token “{Age_Group}” can be replaced with an age group specified by the different organization (or determined to be of interest to the different organization). Thus, even if the highlight from which the rule was created addressed a goal relating to a given segment (e.g., ages 18-24), the rule can be used to create a different highlight that also addresses the same goal but for a different, specified market segment (e.g., ages 45-60). In some embodiments, any segments corresponding to a product (or product type) (e.g., a particular device model, a brand name, etc.) that were specified for a given highlight can be replaced with a corresponding token (e.g., “{Product}”). In this example, when the rule is used to generate a corresponding highlight for a different organization, any instances of the token “{Product}” can be replaced with any products specified by the different organization (or otherwise associated with the different organization). As a result, if the highlight from which the rule was created addressed a goal relating to a given product model (e.g., Device x500), the rule can be used to create a different highlight that also addresses the goal but for a different, specified product model (e.g., Device x600).

The distribution module 308 can be configured to generate highlights from rules. In some embodiments, the distribution module 308 can automatically generate highlights from rules that are applicable to users affiliated with a given organization. For example, a user affiliated with some organization may specify a goal (e.g., increase market share) for a specified demographic segment (e.g., 18-24 age group). In this example, the distribution module 308 can identify any rules that satisfy the user's intent. For example, the distribution module 308 can identify rules that correspond to the specified goal (e.g., increase market share) and also include one or more tokens that reference the specified demographic segment (i.e., age group). The distribution module 308 can then generate corresponding highlights based on the identified rules. These highlights can be customized for the organization as described above. For example, any information included in the highlights (e.g., data analytics, visualizations, interactive maps, etc.) can be customized based on the organization's data. In various embodiments, these generated highlights are published in the organization's content feed and made accessible to users of affiliated with the organization.

FIG. 4A illustrates an example 400 of an interface 402, according to an embodiment of the present disclosure. In this example, the interface 402 may be provided by a software application running on a computing device. The interface 402 includes options for creating a highlight to be published in one or more content feeds. In the example of FIG. 4A, a user operating the computing device can create a highlight by specifying one or more parameters 404 that relate to the highlight. For example, the user can specify one or more geographic regions that are addressed by the highlight. In some embodiments, these geographic regions can be specified using an interactive map 406. The user can also specify a goal 408 that is addressed by the highlight, a title for the highlight, a description of the highlight, and one or more segments 410 (e.g., demographic segments) that relate to the highlight. The user can then select the option 412 to create the highlight. Once created, the highlight can be published in a content feed of an organization with which the user is affiliated or otherwise associated, as illustrated in the example of FIG. 4B. The example of FIG. 4B illustrates a content feed 422 of the organization with which the user is affiliated. In this example, the content feed 422 includes the highlight 424 that was created by the user. In some embodiments, the user can filter highlights shown in the content feed 422 based on a selected goal 426. For example, the user can specify a goal for increasing market share 428. In this example, the content feed 422 can be filtered so that only highlights that relate to the goal of increasing market share 428 are presented in the content feed 422. The highlight 424 can be accessed by other users that are also affiliated with the organization. When accessed, the highlight 424 can provide any information (e.g., data analytics information, visualizations, interactive maps, etc.) associated with the highlight 424 based on any goals, geographic regions, and/or segments that were specified for the highlight 424. This information can be customized based on data (e.g., customer data) associated with the organization for which the highlight 424 was generated. FIG. 4C illustrates an example of the highlight 424. In the example of FIG. 4C, any insights, or information, associated with the highlight 424 can be provided through the interface. As shown, FIG. 4C includes a map visualization 442 that was generated based on parameters specified for the highlight 424. In some embodiments, a user can select options 444 to share the highlight 424 with other users, to export data from the highlight 424, or to provide feedback for the highlight 424. In some embodiments, the highlight 424 can be converted to a rule from which similar highlights can be generated for other organizations as described above. In such embodiments, a highlight being generated from the rule for a different organization can be customized based on parameters specified by the different organization and based on the different organization's own customer data. This highlight can then be published in a content feed associated with the different organization.

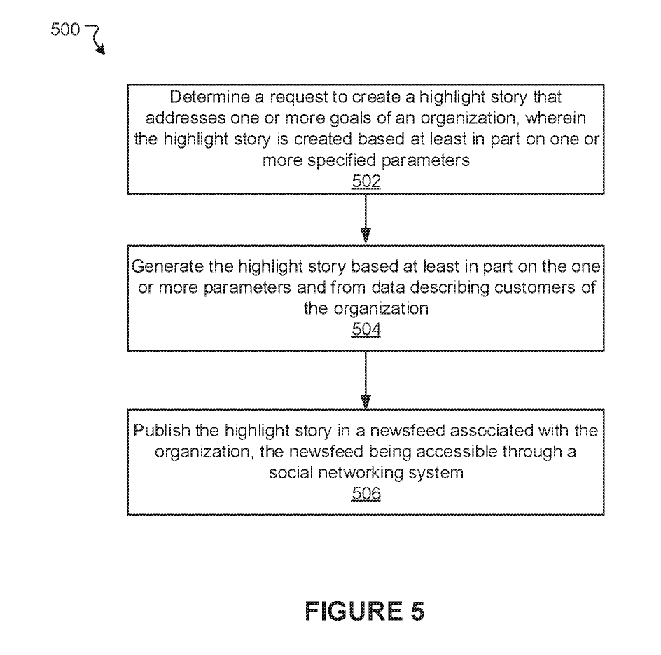

FIG. 5 illustrates an example process 500, according to various embodiments of the present disclosure. It should be appreciated that there can be additional, fewer, or alternative steps performed in similar or alternative orders, or in parallel, within the scope of the various embodiments discussed herein unless otherwise stated.

At block 502, a request to create a highlight story that addresses one or more goals of an organization is determined. The highlight story is created based at least in part on one or more specified parameters. At block 504, the highlight story is generated based at least in part on the one or more parameters and from data describing customers of the organization. At block 506, the highlight story can be published in a newsfeed associated with the organization, the newsfeed being accessible through a social networking system.

It is contemplated that there can be many other uses, applications, and/or variations associated with the various embodiments of the present disclosure. For example, in some cases, user can choose whether or not to opt-in to utilize the disclosed technology. The disclosed technology can also ensure that various privacy settings and preferences are maintained and can prevent private information from being divulged. In another example, various embodiments of the present disclosure can learn, improve, and/or be refined over time.

### Social Networking System—Example Implementation

FIG. 6 illustrates a network diagram of an example system 600 that can be utilized in various scenarios, in accordance with an embodiment of the present disclosure. The system 600 includes one or more user devices 610, one or more external systems 620, a social networking system (or service) 630, and a network 650. In an embodiment, the social networking service, provider, and/or system discussed in connection with the embodiments described above may be implemented as the social networking system 630. For purposes of illustration, the embodiment of the system 600, shown by FIG. 6, includes a single external system 620 and a single user device 610. However, in other embodiments, the system 600 may include more user devices 610 and/or more external systems 620. In certain embodiments, the social networking system 630 is operated by a social network provider, whereas the external systems 620 are separate from the social networking system 630 in that they may be operated by different entities. In various embodiments, however, the social networking system 630 and the external systems 620 operate in conjunction to provide social networking services to users (or members) of the social networking system 630. In this sense, the social networking system 630 provides a platform or backbone, which other systems, such as external systems 620, may use to provide social networking services and functionalities to users across the Internet.

The user device 610 comprises one or more computing devices (or systems) that can receive input from a user and transmit and receive data via the network 650. In one embodiment, the user device 610 is a conventional computer system executing, for example, a Microsoft Windows compatible operating system (OS), Apple OS X, and/or a Linux distribution. In another embodiment, the user device 610 can be a computing device or a device having computer functionality, such as a smart-phone, a tablet, a personal digital assistant (PDA), a mobile telephone, a laptop computer, a wearable device (e.g., a pair of glasses, a watch, a bracelet, etc.), a camera, an appliance, etc. The user device 610 is configured to communicate via the network 650. The user device 610 can execute an application, for example, a browser application that allows a user of the user device 610 to interact with the social networking system 630. In another embodiment, the user device 610 interacts with the social networking system 630 through an application programming interface (API) provided by the native operating system of the user device 610, such as iOS and ANDROID. The user device 610 is configured to communicate with the external system 620 and the social networking system 630 via the network 650, which may comprise any combination of local area and/or wide area networks, using wired and/or wireless communication systems.

In one embodiment, the network 650 uses standard communications technologies and protocols. Thus, the network 650 can include links using technologies such as Ethernet, 802.11, worldwide interoperability for microwave access (WiMAX), 3G, 4G, CDMA, GSM, LTE, digital subscriber line (DSL), etc. Similarly, the networking protocols used on the network 650 can include multiprotocol label switching (MPLS), transmission control protocol/Internet protocol (TCP/IP), User Datagram Protocol (UDP), hypertext transport protocol (HTTP), simple mail transfer protocol (SMTP), file transfer protocol (FTP), and the like. The data exchanged over the network 650 can be represented using technologies and/or formats including hypertext markup language (HTML) and extensible markup language (XML). In addition, all or some links can be encrypted using conventional encryption technologies such as secure sockets layer (SSL), transport layer security (TLS), and Internet Protocol security (IPsec).

In one embodiment, the user device 610 may display content from the external system 620 and/or from the social networking system 630 by processing a markup language document 614 received from the external system 620 and from the social networking system 630 using a browser application 612. The markup language document 614 identifies content and one or more instructions describing formatting or presentation of the content. By executing the instructions included in the markup language document 614, the browser application 612 displays the identified content using the format or presentation described by the markup language document 614. For example, the markup language document 614 includes instructions for generating and displaying a web page having multiple frames that include text and/or image data retrieved from the external system 620 and the social networking system 630. In various embodiments, the markup language document 614 comprises a data file including extensible markup language (XML) data, extensible hypertext markup language (XHTML) data, or other markup language data. Additionally, the markup language document 614 may include JavaScript Object Notation (JSON) data, JSON with padding (JSONP), and JavaScript data to facilitate data-interchange between the external system 620 and the user device 610. The browser application 612 on the user device 610 may use a JavaScript compiler to decode the markup language document 614.

The markup language document 614 may also include, or link to, applications or application frameworks such as FLASH™ or Unity™ applications, the Silverlight™ application framework, etc.

In one embodiment, the user device 610 also includes one or more cookies 616 including data indicating whether a user of the user device 610 is logged into the social networking system 630, which may enable modification of the data communicated from the social networking system 630 to the user device 610.

The external system 620 includes one or more web servers that include one or more web pages 622a, 622b, which are communicated to the user device 610 using the network 650. The external system 620 is separate from the social networking system 630. For example, the external system 620 is associated with a first domain, while the social networking system 630 is associated with a separate social networking domain. Web pages 622a, 622b, included in the external system 620, comprise markup language documents 614 identifying content and including instructions specifying formatting or presentation of the identified content. As discussed previously, it should be appreciated that there can be many variations or other possibilities.

The social networking system 630 includes one or more computing devices for a social network, including a plurality of users, and providing users of the social network with the ability to communicate and interact with other users of the social network. In some instances, the social network can be represented by a graph, i.e., a data structure including edges and nodes. Other data structures can also be used to represent the social network, including but not limited to databases, objects, classes, meta elements, files, or any other data structure. The social networking system 630 may be administered, managed, or controlled by an operator. The operator of the social networking system 630 may be a human being, an automated application, or a series of applications for managing content, regulating policies, and collecting usage metrics within the social networking system 630. Any type of operator may be used.

Users may join the social networking system 630 and then add connections to any number of other users of the social networking system 630 to whom they desire to be connected. As used herein, the term “friend” refers to any other user of the social networking system 630 to whom a user has formed a connection, association, or relationship via the social networking system 630. For example, in an embodiment, if users in the social networking system 630 are represented as nodes in the social graph, the term “friend” can refer to an edge formed between and directly connecting two user nodes.

Connections may be added explicitly by a user or may be automatically created by the social networking system 630 based on common characteristics of the users (e.g., users who are alumni of the same educational institution). For example, a first user specifically selects a particular other user to be a friend. Connections in the social networking system 630 are usually in both directions, but need not be, so the terms “user” and “friend” depend on the frame of reference. Connections between users of the social networking system 630 are usually bilateral (“two-way”), or “mutual,” but connections may also be unilateral, or “one-way.” For example, if Bob and Joe are both users of the social networking system 630 and connected to each other, Bob and Joe are each other's connections. If, on the other hand, Bob wishes to connect to Joe to view data communicated to the social networking system 630 by Joe, but Joe does not wish to form a mutual connection, a unilateral connection may be established. The connection between users may be a direct connection; however, some embodiments of the social networking system 630 allow the connection to be indirect via one or more levels of connections or degrees of separation.

In addition to establishing and maintaining connections between users and allowing interactions between users, the social networking system 630 provides users with the ability to take actions on various types of items supported by the social networking system 630. These items may include groups or networks (i.e., social networks of people, entities, and concepts) to which users of the social networking system 630 may belong, events or calendar entries in which a user might be interested, computer-based applications that a user may use via the social networking system 630, transactions that allow users to buy or sell items via services provided by or through the social networking system 630, and interactions with advertisements that a user may perform on or off the social networking system 630. These are just a few examples of the items upon which a user may act on the social networking system 630, and many others are possible. A user may interact with anything that is capable of being represented in the social networking system 630 or in the external system 620, separate from the social networking system 630, or coupled to the social networking system 630 via the network 650.

The social networking system 630 is also capable of linking a variety of entities. For example, the social networking system 630 enables users to interact with each other as well as external systems 620 or other entities through an API, a web service, or other communication channels. The social networking system 630 generates and maintains the “social graph” comprising a plurality of nodes interconnected by a plurality of edges. Each node in the social graph may represent an entity that can act on another node and/or that can be acted on by another node. The social graph may include various types of nodes. Examples of types of nodes include users, non-person entities, content items, web pages, groups, activities, messages, concepts, and any other things that can be represented by an object in the social networking system 630. An edge between two nodes in the social graph may represent a particular kind of connection, or association, between the two nodes, which may result from node relationships or from an action that was performed by one of the nodes on the other node. In some cases, the edges between nodes can be weighted. The weight of an edge can represent an attribute associated with the edge, such as a strength of the connection or association between nodes. Different types of edges can be provided with different weights. For example, an edge created when one user “likes” another user may be given one weight, while an edge created when a user befriends another user may be given a different weight.

As an example, when a first user identifies a second user as a friend, an edge in the social graph is generated connecting a node representing the first user and a second node representing the second user. As various nodes relate or interact with each other, the social networking system 630 modifies edges connecting the various nodes to reflect the relationships and interactions.

The social networking system 630 also includes user-generated content, which enhances a user's interactions with the social networking system 630. User-generated content may include anything a user can add, upload, send, or “post” to the social networking system 630. For example, a user communicates posts to the social networking system 630 from a user device 610. Posts may include data such as status updates or other textual data, location information, images such as photos, videos, links, music or other similar data and/or media. Content may also be added to the social networking system 630 by a third party. Content “items” are represented as objects in the social networking system 630. In this way, users of the social networking system 630 are encouraged to communicate with each other by posting text and content items of various types of media through various communication channels. Such communication increases the interaction of users with each other and increases the frequency with which users interact with the social networking system 630.

The social networking system 630 includes a web server 632, an API request server 634, a user profile store 636, a connection store 638, an action logger 640, an activity log 642, and an authorization server 644. In an embodiment of the invention, the social networking system 630 may include additional, fewer, or different components for various applications. Other components, such as network interfaces, security mechanisms, load balancers, failover servers, management and network operations consoles, and the like are not shown so as to not obscure the details of the system.

The user profile store 636 maintains information about user accounts, including biographic, demographic, and other types of descriptive information, such as work experience, educational history, hobbies or preferences, location, and the like that has been declared by users or inferred by the social networking system 630. This information is stored in the user profile store 636 such that each user is uniquely identified. The social networking system 630 also stores data describing one or more connections between different users in the connection store 638. The connection information may indicate users who have similar or common work experience, group memberships, hobbies, or educational history. Additionally, the social networking system 630 includes user-defined connections between different users, allowing users to specify their relationships with other users. For example, user-defined connections allow users to generate relationships with other users that parallel the users' real-life relationships, such as friends, co-workers, partners, and so forth. Users may select from predefined types of connections, or define their own connection types as needed. Connections with other nodes in the social networking system 630, such as non-person entities, buckets, cluster centers, images, interests, pages, external systems, concepts, and the like are also stored in the connection store 638.

The social networking system 630 maintains data about objects with which a user may interact. To maintain this data, the user profile store 636 and the connection store 638 store instances of the corresponding type of objects maintained by the social networking system 630. Each object type has information fields that are suitable for storing information appropriate to the type of object. For example, the user profile store 636 contains data structures with fields suitable for describing a user's account and information related to a user's account. When a new object of a particular type is created, the social networking system 630 initializes a new data structure of the corresponding type, assigns a unique object identifier to it, and begins to add data to the object as needed. This might occur, for example, when a user becomes a user of the social networking system 630, the social networking system 630 generates a new instance of a user profile in the user profile store 636, assigns a unique identifier to the user account, and begins to populate the fields of the user account with information provided by the user.

The connection store 638 includes data structures suitable for describing a user's connections to other users, connections to external systems 620 or connections to other entities. The connection store 638 may also associate a connection type with a user's connections, which may be used in conjunction with the user's privacy setting to regulate access to information about the user. In an embodiment of the invention, the user profile store 636 and the connection store 638 may be implemented as a federated database.

Data stored in the connection store 638, the user profile store 636, and the activity log 642 enables the social networking system 630 to generate the social graph that uses nodes to identify various objects and edges connecting nodes to identify relationships between different objects. For example, if a first user establishes a connection with a second user in the social networking system 630, user accounts of the first user and the second user from the user profile store 636 may act as nodes in the social graph. The connection between the first user and the second user stored by the connection store 638 is an edge between the nodes associated with the first user and the second user. Continuing this example, the second user may then send the first user a message within the social networking system 630. The action of sending the message, which may be stored, is another edge between the two nodes in the social graph representing the first user and the second user. Additionally, the message itself may be identified and included in the social graph as another node connected to the nodes representing the first user and the second user.

In another example, a first user may tag a second user in an image that is maintained by the social networking system 630 (or, alternatively, in an image maintained by another system outside of the social networking system 630). The image may itself be represented as a node in the social networking system 630. This tagging action may create edges between the first user and the second user as well as create an edge between each of the users and the image, which is also a node in the social graph. In yet another example, if a user confirms attending an event, the user and the event are nodes obtained from the user profile store 636, where the attendance of the event is an edge between the nodes that may be retrieved from the activity log 642. By generating and maintaining the social graph, the social networking system 630 includes data describing many different types of objects and the interactions and connections among those objects, providing a rich source of socially relevant information.

The web server 632 links the social networking system 630 to one or more user devices 610 and/or one or more external systems 620 via the network 650. The web server 632 serves web pages, as well as other web-related content, such as Java, JavaScript, Flash, XML, and so forth. The web server 632 may include a mail server or other messaging functionality for receiving and routing messages between the social networking system 630 and one or more user devices 610. The messages can be instant messages, queued messages (e.g., email), text and SMS messages, or any other suitable messaging format.

The API request server 634 allows one or more external systems 620 and user devices 610 to call access information from the social networking system 630 by calling one or more API functions. The API request server 634 may also allow external systems 620 to send information to the social networking system 630 by calling APIs. The external system 620, in one embodiment, sends an API request to the social networking system 630 via the network 650, and the API request server 634 receives the API request. The API request server 634 processes the request by calling an API associated with the API request to generate an appropriate response, which the API request server 634 communicates to the external system 620 via the network 650. For example, responsive to an API request, the API request server 634 collects data associated with a user, such as the user's connections that have logged into the external system 620, and communicates the collected data to the external system 620. In another embodiment, the user device 610 communicates with the social networking system 630 via APIs in the same manner as external systems 620.

The action logger 640 is capable of receiving communications from the web server 632 about user actions on and/or off the social networking system 630. The action logger 640 populates the activity log 642 with information about user actions, enabling the social networking system 630 to discover various actions taken by its users within the social networking system 630 and outside of the social networking system 630. Any action that a particular user takes with respect to another node on the social networking system 630 may be associated with each user's account, through information maintained in the activity log 642 or in a similar database or other data repository. Examples of actions taken by a user within the social networking system 630 that are identified and stored may include, for example, adding a connection to another user, sending a message to another user, reading a message from another user, viewing content associated with another user, attending an event posted by another user, posting an image, attempting to post an image, or other actions interacting with another user or another object. When a user takes an action within the social networking system 630, the action is recorded in the activity log 642. In one embodiment, the social networking system 630 maintains the activity log 642 as a database of entries. When an action is taken within the social networking system 630, an entry for the action is added to the activity log 642. The activity log 642 may be referred to as an action log.

Additionally, user actions may be associated with concepts and actions that occur within an entity outside of the social networking system 630, such as an external system 620 that is separate from the social networking system 630. For example, the action logger 640 may receive data describing a user's interaction with an external system 620 from the web server 632. In this example, the external system 620 reports a user's interaction according to structured actions and objects in the social graph.

Other examples of actions where a user interacts with an external system 620 include a user expressing an interest in an external system 620 or another entity, a user posting a comment to the social networking system 630 that discusses an external system 620 or a web page 622a within the external system 620, a user posting to the social networking system 630 a Uniform Resource Locator (URL) or other identifier associated with an external system 620, a user attending an event associated with an external system 620, or any other action by a user that is related to an external system 620. Thus, the activity log 642 may include actions describing interactions between a user of the social networking system 630 and an external system 620 that is separate from the social networking system 630.

The authorization server 644 enforces one or more privacy settings of the users of the social networking system 630. A privacy setting of a user determines how particular information associated with a user can be shared. The privacy setting comprises the specification of particular information associated with a user and the specification of the entity or entities with whom the information can be shared. Examples of entities with which information can be shared may include other users, applications, external systems 620, or any entity that can potentially access the information. The information that can be shared by a user comprises user account information, such as profile photos, phone numbers associated with the user, user's connections, actions taken by the user such as adding a connection, changing user profile information, and the like.

The privacy setting specification may be provided at different levels of granularity. For example, the privacy setting may identify specific information to be shared with other users; the privacy setting identifies a work phone number or a specific set of related information, such as, personal information including profile photo, home phone number, and status. Alternatively, the privacy setting may apply to all the information associated with the user. The specification of the set of entities that can access particular information can also be specified at various levels of granularity. Various sets of entities with which information can be shared may include, for example, all friends of the user, all friends of friends, all applications, or all external systems 620. One embodiment allows the specification of the set of entities to comprise an enumeration of entities. For example, the user may provide a list of external systems 620 that are allowed to access certain information. Another embodiment allows the specification to comprise a set of entities along with exceptions that are not allowed to access the information. For example, a user may allow all external systems 620 to access the user's work information, but specify a list of external systems 620 that are not allowed to access the work information. Certain embodiments call the list of exceptions that are not allowed to access certain information a “block list”. External systems 620 belonging to a block list specified by a user are blocked from accessing the information specified in the privacy setting. Various combinations of granularity of specification of information, and granularity of specification of entities, with which information is shared are possible. For example, all personal information may be shared with friends whereas all work information may be shared with friends of friends.

The authorization server 644 contains logic to determine if certain information associated with a user can be accessed by a user's friends, external systems 620, and/or other applications and entities. The external system 620 may need authorization from the authorization server 644 to access the user's more private and sensitive information, such as the user's work phone number. Based on the user's privacy settings, the authorization server 644 determines if another user, the external system 620, an application, or another entity is allowed to access information associated with the user, including information about actions taken by the user.

In some embodiments, the social networking system 630 can include a data insights module 646. The data insights module 646 can, for example, be implemented as the data insights module 102 of FIG. 1. The data insights module 646 may also be implemented, in whole or in part, in the user device 610. As discussed previously, it should be appreciated that there can be many variations or other possibilities.

### Hardware Implementation

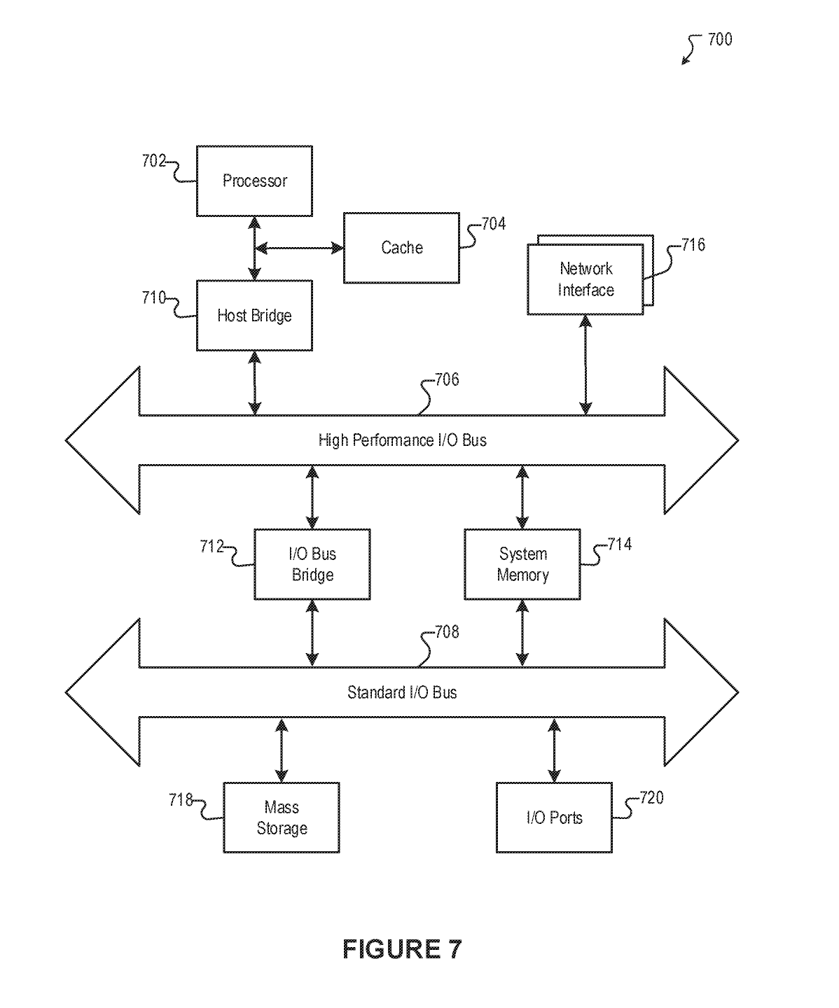

The foregoing processes and features can be implemented by a wide variety of machine and computer system architectures and in a wide variety of network and computing environments. FIG. 7 illustrates an example of a computer system 700 that may be used to implement one or more of the embodiments described herein in accordance with an embodiment of the invention. The computer system 700 includes sets of instructions for causing the computer system 700 to perform the processes and features discussed herein. The computer system 700 may be connected (e.g., networked) to other machines. In a networked deployment, the computer system 700 may operate in the capacity of a server machine or a client machine in a client-server network environment, or as a peer machine in a peer-to-peer (or distributed) network environment. In an embodiment of the invention, the computer system 700 may be the social networking system 630, the user device 610, and the external system 720, or a component thereof. In an embodiment of the invention, the computer system 700 may be one server among many that constitutes all or part of the social networking system 630.

The computer system 700 includes a processor 702, a cache 704, and one or more executable modules and drivers, stored on a computer-readable medium, directed to the processes and features described herein. Additionally, the computer system 700 includes a high performance input/output (I/O) bus 706 and a standard I/O bus 708. A host bridge 710 couples processor 702 to high performance I/O bus 706, whereas I/O bus bridge 712 couples the two buses 706 and 708 to each other. A system memory 714 and one or more network interfaces 716 couple to high performance I/O bus 706. The computer system 700 may further include video memory and a display device coupled to the video memory (not shown). Mass storage 718 and I/O ports 720 couple to the standard I/O bus 708. The computer system 700 may optionally include a keyboard and pointing device, a display device, or other input/output devices (not shown) coupled to the standard I/O bus 708. Collectively, these elements are intended to represent a broad category of computer hardware systems, including but not limited to computer systems based on the x86-compatible processors manufactured by Intel Corporation of Santa Clara, Calif., and the x86-compatible processors manufactured by Advanced Micro Devices (AMD), Inc., of Sunnyvale, Calif., as well as any other suitable processor.

An operating system manages and controls the operation of the computer system 700, including the input and output of data to and from software applications (not shown). The operating system provides an interface between the software applications being executed on the system and the hardware components of the system. Any suitable operating system may be used, such as the LINUX Operating System, the Apple Macintosh Operating System, available from Apple Computer Inc. of Cupertino, Calif., UNIX operating systems, Microsoft® Windows® operating systems, BSD operating systems, and the like. Other implementations are possible.

The elements of the computer system 700 are described in greater detail below. In particular, the network interface 716 provides communication between the computer system 700 and any of a wide range of networks, such as an Ethernet (e.g., IEEE 802.3) network, a backplane, etc. The mass storage 718 provides permanent storage for the data and programming instructions to perform the above-described processes and features implemented by the respective computing systems identified above, whereas the system memory 714 (e.g., DRAM) provides temporary storage for the data and programming instructions when executed by the processor 702. The I/O ports 720 may be one or more serial and/or parallel communication ports that provide communication between additional peripheral devices, which may be coupled to the computer system 700.

The computer system 700 may include a variety of system architectures, and various components of the computer system 700 may be rearranged. For example, the cache 704 may be on-chip with processor 702. Alternatively, the cache 704 and the processor 702 may be packed together as a “processor module”, with processor 702 being referred to as the “processor core”. Furthermore, certain embodiments of the invention may neither require nor include all of the above components. For example, peripheral devices coupled to the standard I/O bus 708 may couple to the high performance I/O bus 706. In addition, in some embodiments, only a single bus may exist, with the components of the computer system 700 being coupled to the single bus. Moreover, the computer system 700 may include additional components, such as additional processors, storage devices, or memories.

In general, the processes and features described herein may be implemented as part of an operating system or a specific application, component, program, object, module, or series of instructions referred to as “programs”. For example, one or more programs may be used to execute specific processes described herein. The programs typically comprise one or more instructions in various memory and storage devices in the computer system 700 that, when read and executed by one or more processors, cause the computer system 700 to perform operations to execute the processes and features described herein. The processes and features described herein may be implemented in software, firmware, hardware (e.g., an application specific integrated circuit), or any combination thereof.

In one implementation, the processes and features described herein are implemented as a series of executable modules run by the computer system 700, individually or collectively in a distributed computing environment. The foregoing modules may be realized by hardware, executable modules stored on a computer-readable medium (or machine-readable medium), or a combination of both. For example, the modules may comprise a plurality or series of instructions to be executed by a processor in a hardware system, such as the processor 702. Initially, the series of instructions may be stored on a storage device, such as the mass storage 718. However, the series of instructions can be stored on any suitable computer readable storage medium. Furthermore, the series of instructions need not be stored locally, and could be received from a remote storage device, such as a server on a network, via the network interface 716. The instructions are copied from the storage device, such as the mass storage 718, into the system memory 714 and then accessed and executed by the processor 702. In various implementations, a module or modules can be executed by a processor or multiple processors in one or multiple locations, such as multiple servers in a parallel processing environment.

Examples of computer-readable media include, but are not limited to, recordable type media such as volatile and non-volatile memory devices; solid state memories; floppy and other removable disks; hard disk drives; magnetic media; optical disks (e.g., Compact Disk Read-Only Memory (CD ROMS), Digital Versatile Disks (DVDs)); other similar non-transitory (or transitory), tangible (or non-tangible) storage medium; or any type of medium suitable for storing, encoding, or carrying a series of instructions for execution by the computer system 700 to perform any one or more of the processes and features described herein.

For purposes of explanation, numerous specific details are set forth in order to provide a thorough understanding of the description. It will be apparent, however, to one skilled in the art that embodiments of the disclosure can be practiced without these specific details. In some instances, modules, structures, processes, features, and devices are shown in block diagram form in order to avoid obscuring the description. In other instances, functional block diagrams and flow diagrams are shown to represent data and logic flows. The components of block diagrams and flow diagrams (e.g., modules, blocks, structures, devices, features, etc.) may be variously combined, separated, removed, reordered, and replaced in a manner other than as expressly described and depicted herein.

Reference in this specification to “one embodiment”, “an embodiment”, “other embodiments”, “one series of embodiments”, “some embodiments”, “various embodiments”, or the like means that a particular feature, design, structure, or characteristic described in connection with the embodiment is included in at least one embodiment of the disclosure. The appearances of, for example, the phrase “in one embodiment” or “in an embodiment” in various places in the specification are not necessarily all referring to the same embodiment, nor are separate or alternative embodiments mutually exclusive of other embodiments. Moreover, whether or not there is express reference to an “embodiment” or the like, various features are described, which may be variously combined and included in some embodiments, but also variously omitted in other embodiments. Similarly, various features are described that may be preferences or requirements for some embodiments, but not other embodiments.

The language used herein has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A computer-implemented method comprising:
determining, by a computing system, a request to create a highlight story that addresses one or more goals of an organization, wherein the highlight story is created based at least in part on one or more specified parameters;
generating, by the computing system, the highlight story based at least in part on the one or more parameters and from data describing customers of the organization; and
causing, by the computing system, the highlight story to be published in a newsfeed associated with the organization, the newsfeed being accessible through a social networking system.

2. The computer-implemented method of claim 1, wherein the one or more parameters include one or more of a specified geographic region, a market segment, or a product type.

3. The computer-implemented method of claim 1, wherein the highlight story is associated with at least one query for generating a visualization based at least in part on the one or more specified parameters, wherein the visualization is accessible upon selection of the highlight story.

4. The computer-implemented method of claim 3, wherein the visualization includes at least an interactive map corresponding to a specified geographic region, wherein the interactive map provides a visual distribution of a specified market segment within the geographic region.

5. The computer-implemented method of claim 1, wherein a goal corresponds to at least one of: a goal for increasing market share, a goal for improving customer retention, a goal for a product launch, a goal for increasing margins, a goal for optimizing media spend, a goal for optimizing a local strategy, or a goal for customer acquisition.

6. The computer-implemented method of claim 1, the method further comprising:
converting, by the computing system, the highlight story to a rule, wherein the rule is used to generate one or more highlight stories for other organizations to achieve the one or more goals.

7. The computer-implemented method of claim 6, wherein converting the first highlight to the rule further comprises:
identifying, by the computing system, at least one corresponding token for each of the one or more parameters; and
replacing, by the computing system, the one or more parameters with their corresponding tokens, wherein each token serves as a placeholder for a parameter value.

8. The computer-implemented method of claim 6, wherein converting the first highlight to the rule further comprises:
determining, by the computing system, that the highlight story has received a threshold amount of interaction by one or more users associated with the first organization.

9. The computer-implemented method of claim 6, the method further comprising:
generating, by the computing system, at least one second highlight story that provides insights for achieving the one or more goals by a second organization, wherein the second highlight story is generated based at least in part on the rule and data describing customers of the second organization.

10. The computer-implemented method of claim 9, wherein the second highlight story is generated in response to the second organization not having satisfied a given goal by some specified threshold amount.

11. A system comprising:
at least one processor; and
a memory storing instructions that, when executed by the at least one processor, cause the system to perform:
determining a request to create a highlight story that addresses one or more goals of an organization, wherein the highlight story is created based at least in part on one or more specified parameters;
generating the highlight story based at least in part on the one or more parameters and from data describing customers of the organization; and
causing the highlight story to be published in a newsfeed associated with the organization, the newsfeed being accessible through a social networking system.

12. The system of claim 11, wherein the one or more parameters include one or more of a specified geographic region, a market segment, or a product type.

13. The system of claim 11, wherein the highlight story is associated with at least one query for generating a visualization based at least in part on the one or more specified parameters, wherein the visualization is accessible upon selection of the highlight story.

14. The system of claim 13, wherein the visualization includes at least an interactive map corresponding to a specified geographic region, wherein the interactive map provides a visual distribution of a specified market segment within the geographic region.

15. The system of claim 11, wherein a goal corresponds to at least one of: a goal for increasing market share, a goal for improving customer retention, a goal for a product launch, a goal for increasing margins, a goal for optimizing media spend, a goal for optimizing a local strategy, or a goal for customer acquisition.

16. A non-transitory computer-readable storage medium including instructions that, when executed by at least one processor of a computing system, cause the computing system to perform a method comprising:
determining a request to create a highlight story that addresses one or more goals of an organization, wherein the highlight story is created based at least in part on one or more specified parameters;
generating the highlight story based at least in part on the one or more parameters and from data describing customers of the organization; and
causing the highlight story to be published in a newsfeed associated with the organization, the newsfeed being accessible through a social networking system.

17. The non-transitory computer-readable storage medium of claim 16, wherein the one or more parameters include one or more of a specified geographic region, a market segment, or a product type.

18. The non-transitory computer-readable storage medium of claim 16, wherein the highlight story is associated with at least one query for generating a visualization based at least in part on the one or more specified parameters, wherein the visualization is accessible upon selection of the highlight story.

19. The non-transitory computer-readable storage medium of claim 18, wherein the visualization includes at least an interactive map corresponding to a specified geographic region, wherein the interactive map provides a visual distribution of a specified market segment within the geographic region.

20. The non-transitory computer-readable storage medium of claim 16, wherein a goal corresponds to at least one of: a goal for increasing market share, a goal for improving customer retention, a goal for a product launch, a goal for increasing margins, a goal for optimizing media spend, a goal for optimizing a local strategy, or a goal for customer acquisition.
